(19) United States
(12) Patent Application Publication
(10) Pub. No.: US 2010/0075136 A1
(43) Pub. Date: Mar. 25, 2010

(54) Functional Nanofilms

(76) Inventor: Kevin Sun Song, Green Brook, NJ (US)

Correspondence Address: Kevin Song, 1 Windy Hill Road, Green Brook, NJ, 08812, US

(21) Appl. No.: 12/234,572

(22) Filed: Sep. 19, 2008

(51) Int. Cl. B32B 5/16

(52) U.S. Cl. 428/328; 428/411.1; 428/702

(57) ABSTRACT

The present invention claims iridescent multilayer nanofilms with various functionalities. The nanofilms selectively reflect light in the visible light range and comprise a plurality of first optical layers, each first optical layer containing a first functional additive; and a plurality of second optical layers, each second optical layer optionally containing a second functional additive.

### FIELD OF THE INVENTION

This invention relates to multilayer selective light-reflecting or light-absorbing iridescent films with nanostructures.

### BACKGROUND OF THE INVENTION

It was known that when multilayer films are composed of a plurality of generally parallel layers of transparent thermoplastic resinous material in which the contiguous adjacent layers are of diverse resinous material whose index of refraction differs by at least about 0.03, the multiple reflections from the interface of the multilayer may show iridescence due to the light phase shifting and interference of the reflections.

The individual layers of the film are very thin, usually in the range of about 30 to 500 nm, preferably from about 50 to 400 nm, which causes constructive interference in light waves reflected from the many interfaces. Depending on the layer thickness and the refractive index of the polymers, one dominant wavelength band is reflected and the remaining light is transmitted through the film. The reflected wavelength is proportional to the sum of the optical thickness of a pair of layers.

The quantity of the reflected light and the color intensity depend on the difference between the two refractive indices, on the ratio of optical thicknesses of the layers, on the number of layers and on the uniformity of the thickness. If the refractive indices are the same, there is no reflection at all from the interfaces between the layers. In multilayer iridescent films, the refractive indices of contiguous adjacent layers differ by at least 0.03 and preferably by at least 0.06. For first order reflections, reflectance is highest when the optical thicknesses of the layers are equal, although suitably high reflectance can be achieved when the ratio of the two optical thicknesses falls between 5:95 and 95:5. For maximum color intensity it is desired to have the optical core in the multilayer film comprising 35 and 1000 or even more layers. High color intensity is associated with a reflection band which is relatively narrow and which has high reflectance at its peak. It should be recognized that although the term “color intensity” has been used here for convenience, the same considerations apply to the invisible reflection in the ultraviolet and infrared ranges.

When the reflection band occurs within the range of visible wavelength, the films are iridescent. The observed index of reflection in the films may be different from those of the materials. It is known that the effective index differentials of multilayered optical films are often observed to vary somewhat from the values predicted from the corresponding monolithic films. This variance is most pronounced in the thin optical layers (that is, those layers which are tuned to the blue region of the spectrum, or layers that are intentionally made less than ¼ wave thick for other regions of the spectrum). This phenomenon is sometimes attributed, at least in part, to interlayer diffusion. The variations in effective index differential adversely affect the optical properties of the film, with the result that reflective polarizers and other optical films made with these materials often attain only a fraction of their theoretical performance.

In order to maintain the integrity of the multilayer structure in films during manufacture, and to promoting interlayer adhesion between the individual layers, efforts have been made to increase the inter-layer adhesion between co-extruded layers in multilayer optical films to reduce the possibility of delamination during post-processing and end use. Factors that affect inter-layer adhesion and layer integrity include, but are not limited to, the relative affinity of the materials for each layer, the ability of these materials to interact by chemical reaction, the roughness of the inter-layer interface, the broadness of the average concentration profile of the materials across the interfacial zone, the molecular weight and its distribution, melt viscosities of the materials, and the diffusion characteristics of the materials and additives. If the materials chemically react across the interface, inter-layer adhesion may be promoted by the creation of coupling, crosslinking or other forms of covalent bonding, including the formation of copolymers.

U.S. Pat. No. 5,926,424 discloses a method for controlling the effects of interlayer diffusion when producing a multilayer optical film. If the affinity between the materials of adjacent layers is insufficient to cause miscibility, then an interfacial zone will develop over which the concentration of one material varies from nearly its pure value to nearly zero. Since materials are rarely perfectly miscible, the concentration of the material in its original layer is likely to be somewhat less than its original value, and the concentration of the material in layers originally of other materials is likely to be somewhat greater than zero. In cases of partial miscibility, the initially pure material layers may tend to evolve toward thermodynamic phases that maintain a majority of the original material but also contain a substantial portion of material from neighboring layers. Partial miscibility may be the result of the lower molecular weight fractions inherent in, or added to, the polymeric material. As the affinity increases, the effective width of the interfacial zone increases and the ultimate purity of the layers decreases. Changing the purity of the layers can alter their behavior under subsequent processing which may change the optical and mechanical properties of the final film.

It was known that for given materials, processing temperatures and residence times determine how closely to equilibrium the interfacial zone can reach before web quenching at the casting wheel. For example, layers are compressed within the feedblock and then again within the die. An inter-layer profile established in the feedblock could be compressed in the die, requiring further interdiffusion to re-achieve the equilibrium interfacial width. Controlling residence times through the various portions of the melt train can control the degree of interdiffusion and therefore the interfacial adhesion.

One particular use of multilayer polymeric films is in mirrors which reflect light over a particular wavelength range. Such reflective films can be disposed, for example, behind a backlight in liquid crystal displays to reflect light toward the display to enhance brightness of the display. Color shifting films can be used as decorative or packaging materials. IR mirror films can be used, for example, to reduce solar heat load entering a building or vehicle through its windows. Ultraviolet (UV) films can be used to protect other films or objects from UV light to prevent deleterious effects.

U.S. patent application Ser. No. 11/550,799 discloses a multi-function, multi-layer optical film which contains a first hard coat layer on a front surface of a transparent substrate. The first hard coat layer can integrate in itself the anti-glare, anti-smudge, anti-UV, and anti-static functions by blending appropriate amount of specific chemicals into the acrylate resin of the first hard coat layer. The first hard coat layer is made of acrylate resin containing an appropriate amount of polyoxetane polymers with pendant side chain having at least a fluorocarbon (C—F) bond. The constituent fluorine modifies the surface energy of the first hard coat layer so that additional function-enhancing layers can be developed from the front surface of the basic structure reliably.

Coextrusion casting processes have been used to make multilayer optical mirrors. Generally, however, cast films have a number of practical drawbacks. For example, cast films generally have low refractive index differences between the high and low index materials and do not generally have matching refractive indices in the z-direction, limiting the optical performance for a given number of layers. Because of the limited optical power of such cast films, dyes and pigments also typically are used to enhance the color of color mirror films. Moreover, some cast films, particularly films made of noncrystalline materials, can also have limited thermal stability, dimensional stability, environmental stability and/or solvent resistance.

Multilayer films with antiglare properties have been reported. U.S. Pat. No. 6,696,140 discloses a light-transparent film coated with a coating composition comprising non-agglomerative light-transparent fine particles. The light-transparent fine particles have a particle diameter of 1.0 to 5.0 μm and the difference in optical refractive index between the light-transparent fine particles and the light-transparent resin is 0.05 to 0.15.

Efforts have also been made in searching for an ultraviolet-absorbing polymer film which can be employed as an optical filter or a protective film for a polarizing plate of a liquid crystal display, and other ultraviolet-absorbing applications. U.S. Pat. No. 5,806,834 discloses an ultraviolet-absorbing polymer film which is not tinged with yellow and capable of transmitting thoroughly light in a wavelength region of longer than 400 nm, particularly to obtain a film capable of transmitting thoroughly light in a wavelength region of longer than 400 nm and absorb thoroughly light in a wavelength region of not longer than 400 nm.

U.S. Pat. No. 6,480,250 discloses a multilayer film having low reflection and conductive characteristics. The film comprises, in the order described, a transparent substrate, a hard coat layer, a transparent conductive layer containing particles comprising at least one of a metal and a metal oxide, and at least one transparent protective layer which has anti-smudge properties, has a refractive index different from that of the transparent conductive layer and comprises a resin having a high dielectric power factor. It is claimed that the low-reflection transparent conductive film can be used to cover a cathode-ray tube or a plasma display panel used in a TV set or a computer display to perform the desired functions as compared with the conventional vapor deposition techniques such as PVD or CVD or the conventional method comprising applying a conductive coating directly to the face panel.

The optical multilayer films with specific functionality often require a careful balance between the functionality and the transparency. Normally, a higher concentration of functional additives provides better functionality but poorer transparency of the optical films.

Therefore, it is an object of the present invention to have an iridescent multilayer film with both high functionality and strong iridescence. The other objects of the present invention include increasing the efficiency of the functional additives by uniformly dispersing the functional additives in one of the alternating layers. The concentration of the functional additives within the layer is higher without increasing the amount of the functional additives added.

### SUMMARY OF THE INVENTION

In one embodiment of the invention, an iridescent multilayer film comprises an optical core comprising at least 10 alternating layers of at least a first and second layer types and two exterior skin layers; wherein said first layer type comprises a first polymeric resin and a first functional additive; and said second layer type comprises a second polymeric resin and optionally a second functional additive; wherein the difference in index of refraction between the first polymeric resin and second polymeric resin is at least about 0.03.

Preferably, the difference in index of refraction between the first polymeric resin and second polymeric resin is at least about 0.06.

Optionally, the optical core comprises (1) a first layer type comprising a first polymeric resin and a first functional additive and (2) a second layer type comprising a second polymeric resin and a second functional additive.

Optionally, at least one of the two exterior skin layers comprises a polymeric resin which is different from the first, and second polymeric resin and a functional additive.

Optionally, at least one of the first layer type and the second layer type comprises additionally a polymer compatibilizer.

In another embodiment of the invention, an iridescent multilayer film comprises an optical core comprising at least 10 alternating layers of a first, second and third layer types and two exterior skin layers; wherein said first layer type comprises a first polymeric resin and a first functional additive; said second layer type comprises a second polymeric resin and optionally a second functional additive; said third layer type comprises a third polymeric resin and optionally a third functional additive; wherein the difference in index of refraction between the first and second polymeric resins, the first and third polymeric resins, or the second and third polymeric resins is at least about 0.03.

Preferably, the difference in index of refraction between the first and second polymeric resins, the first and third polymeric resins, or the second and third polymeric resins is at least about 0.06.

Optionally, the optical core comprises (1) a first layer type comprising a first polymeric resin and a first functional additive, (2) a second layer type comprising a second polymeric resin and a second functional additive, and (3) a third layer type comprises a third polymeric resin and optionally a third functional additive.

Optionally, the optical core comprises (1) a first layer type comprising a first polymeric resin and a first functional additive, (2) a second layer type comprising a second polymeric resin and a second functional additive, and (3) a third layer type comprises a third polymeric resin and a third functional additive.

Optionally, at least one of the two exterior skin layers comprises a polymeric resin which is different from the first, second and third polymeric resin and a functional additive.

Optionally, at least one of the first, second and third layer types comprises additionally a polymer compatibilizer.

### BRIEF DESCRIPTION OF THE DRAWINGS

The invention may be more completely understood in consideration of the following detailed description of various embodiments of the invention in connection with the accompanying drawings, in which:

FIG. 1 is a schematic cross-sectional diagram of a first embodiment of a functional iridescent film according to the invention;

FIG. 2 is a schematic cross-sectional diagram of a second embodiment of a functional iridescent film according to the invention;

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DESCRIPTION OF EMBODIMENTS

The present invention is generally directed to functional iridescent films with nanostructures, their preparation process, and their use in optical applications as anti-UV, anti-glare and anti-static iridescent films for decorative, packaging, windows, and mirrors. The multilayer iridescent films reflect light over a visible wavelength range. The multilayer iridescent films are typically coextruded and oriented multilayer structures that differ from previous optical bodies, at least in part, due to the addition of functional additives which can provide processing, economic, optical, mechanical, and other advantages.

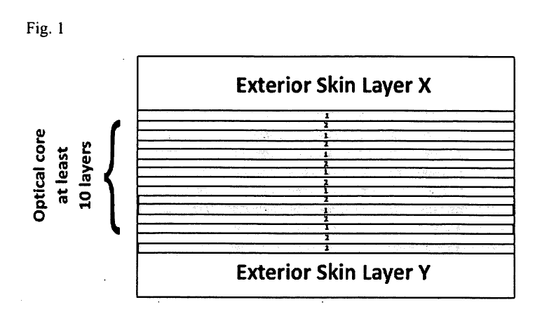

FIG. 1 is a schematic cross-sectional diagram of the first embodiment of a functional iridescent multilayer film according to the invention. The iridescent multilayer film comprises an optical core comprising at less 10 alternating layers of at least a first and second layer types which are labeled in FIG. 1 as layer 1 and layer 2 and two exterior skin layers which are labeled as layer x and layer y; wherein said first layer type comprises a first polymeric resin and a first functional additive; and said second layer type comprises a second polymeric resin and optionally a second functional additive.

When the optical core contains more than ten alternating layers the films may exhibit iridescence if the difference of index of refraction between the first and second polymeric resins is at least 0.03. The iridescent effect increases with the increase of the number of alternating layers and the difference between the index of refraction. The difference of the index of refraction is preferably more than 0.06.

The multilayer structure makes possible a uniform distribution of the functional additive. The functional effect is enhanced since the functional additive can be concentrated to one of the alternating layers. In addition, at least one of the exterior skin layer (layer x or y) may contain a polymeric resin which is different from the first, and second polymeric resins and optionally a functional additive, such as a conductive additive, in order to provide films with anti-static properties. Since the conductivity of the surface of a film determines the anti-static property it is obvious that a high effectiveness and better film optical characteristics can be achieved by adding a conductive additive to only the exterior surface layer.

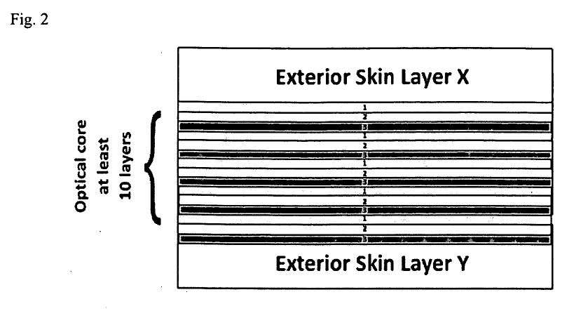

FIG. 2 is a schematic cross-sectional diagram of another embodiment of an iridescent multilayer film according to the invention. The main difference between the first and second embodiments of the invention is that the iridescent multilayer film made according to the second embodiment comprises an optical core comprising at less 10 alternating layers of a first, second and third layer types which are labeled in FIG. 2 as layer 1, layer 2 and layer 3 and two exterior skin layers which are labeled as layer x and layer y; wherein said first layer type comprises a first polymeric resin and a first functional additive; said second layer type comprises a second polymeric resin and optionally a second functional additive; and said third layer type comprises a third polymeric resin and optionally a third functional additive.

At least one of the exterior skin layer (layer x or y) of this embodiment may also contain a polymeric resin which is different from the first, second and third polymeric resins and optionally a functional additive, such as a conductive additive, in order to provide films with anti-static properties.

The polymer resin suitable for making the iridescent multilayer film of this invention as the first, second, or third polymeric resin or the polymeric resin for the exterior skin layers includes without limitation, polyesters, polysulfones, polyamide, polyimides, polyacrylates, polyethers, polyolefins, polyaromatics, polysiloxanes, and other polyvinyl compounds as well as copolymers of two or more monomers of the above-defined polymers. Preferred polyesters include polyethylene terephthalate, polybutylene terephthalate, glycol modified polyethylene terephthalate, and polyethylene naphthalate. Preferred polysulfones include polyethersulfones and polyaryl sulfones. Preferred polyamides include nylon 6, nylon 11, nylon 12, nylon 6/6 and nylon 6/12. Preferred polyimides include polyetherimides. Preferred polyacrylates include polymethyl methacrylate, polymethyl acrylate, polyethyl hydroxymethacrylate, polyethyl hydroxyacrylate, polypropyl hydroxymethacrylate, and polypropyl hydroxyacrylate. Preferred polyethers include polyoxypropylene, polyvinyl isobutyl ether, polyvinyl ethyl ether, polyoxyethylene, polyvinyl butyl ether, polyvinyl pentyl ether, and polyvinyl hexyl ether. Preferred polyolefins include polypropylene, LLDPE, LDPE, HDPE, polyisobutene and copolymers of two or more olefin monomers. Preferred polyaromatics include polystyrene, poly alpha-methyl styrene, and polychlorostyrene. Preferred polysiloxanes include polydimethyl siloxanes. Preferred other vinyl compounds include polyvinyl chloride, polyvinylidene chloride, and polyvinylidene fluoride.

Other suitable polymer resins include but are not limited to poly-1,4-cyclohexanedimethylene terephthalate, nylon 4/6, nylon 6/9, and nylon 6/10, thermoplastic polyacrylic imides, polyamide-imides, polyether-amides, polyphenylene ether, the ring-substituted polyphenylene oxides, polyetheretherketone, aliphatic polyketones, polyphenylene sulfide, atactic polystyrene, syndiotactic polystyrene, syndiotactic poly-alpha-methyl styrene, syndiotactic polydichlorostyrene, polyphenylene oxides, styrene-butadiene copolymers, styrene-acrylonitrile copolymers, acrylonitrilebutadiene-styrene terpolymers, ethyl cellulose, cellulose acetate, cellulose propionate, cellulose acetate butyrate, and cellulose nitrate, polytetrafluoroethylene, polytrifluoroethylene, polyvinyl fluoride, fluorinated ethylene-propylene copolymers, perfluoroalkoxy resins, polychlorotrifluoroethylene, polyethylene-co-trifluoroethylene, polyethylene-co-chlorotrifluoroethylene, polyacrylonitrile, polyvinylacetate, polyoxymethylene and polyethylene oxide, polybutadiene, polyisoprene, and neoprene, poly(ethyl styrene), poly(propyl styrene), poly(butyl styrene), poly(chlorostyrene), poly(bromostyrene), and poly(fluorostyrene), poly(methoxy styrene), poly(ethoxy styrene), poly(m-methyl styrene), poly(p-tertiary butyl styrene), poly(p-chlorostyrene), poly(m-chloro styrene), poly(p-fluoro styrene), and copolymers of styrene and p-methyl styrene as well as epoxy resins, and polyurethanes.

Although there are no particular restrictions regarding the molecular weight of these homopolymer and copolymers, the weight average molecular weight of the polymer is preferably greater than 10,000 and less than 1,000,000, and more preferably, greater than 50,000 and less than 800,000.

The polymeric resins used in this invention can be physical blends of two or more polymers so long as there is no phase separation between the polymeric components.

The functional additives include UV absorbers, conductive additives, nanoparticle additives, oxygen scavengers, and other additives which provide a specific functionality when added to at least one of the first, second, or third polymeric resins or the exterior skin layers.

The typical organic UV absorbers include benzophenone compounds such as 2,1′-dihydroxy-4,4′dimethoxybenzophenone, 2-hydroxy-4-methoxybenzophenone and 2-hydroxy-4-n-dodecyloxybenzophenone; salicylate compounds, such as 4-t-butylphenylsalicylate; benzotriazole compounds, such as 2-(hydroxy-5-t-octylphenyl)benzotriazole, 2-(2′hydroxy-5′-methylphenyl)benzotriazole and 2-(2′-hydroxy3′,5′-di-t-butylphenyl)-5-chlorobenzotriazole; and [2,2′thiobis-(4-t-octylphenolate)]n-butylamine nickel(II).

The typical nanoparticle additives, which are substantially transparent to the visible light but are effective UV blocking agents, are zinc oxide, titanium dioxide, silica oxides, aluminum oxides, and zirconium oxides. The typical nanoparticle additive is spherical particles with an average weight average diameter less than 1 micron, preferably less than 200 nm and most preferably, less than 100 nm.

The nanoparticle additives can also be selected from metal oxide particulates with a mean length of the particles in the range from 50 to 90 nm, and the mean width of the particles in the range from 5 to 20 nm. The particulates are preferably acicular in shape and have a long axis (maximum dimension or length) and short axis (minimum dimension or width). The third axis of the particles (or depth) is preferably approximately the same dimensions as the width. The size of the particulates can be suitably measured using electron microscopy. The size of a particle can be determined by measuring the length and width of a particle selected from a photographic image obtained by using a transmission electron microscope. Mean values can be determined from the measurements of at least 300 particles. The metal oxide particulates preferably have a mean aspect ratio d₁:d₂ (where d₁ and d₂, respectively, are the length and width of the particle) in the range from 2.0 to 8.0:1, more preferably 3.0 to 7.0:1, and most preferably 4.0 to 6.0:1.

The typical conductive additives include, metal powders, metal oxides, carbon black, polypyrrole and its derivatives, polythiophene and its derivatives, polyaniline and its derivatives.

Typical oxygen scavengers include metallic iron, potassium sulfite, unsaturated hydrocarbons, ascorbic acid derivatives, imide containing or amide containing compounds.

The functional additive can be added to the first, second, or third polymeric resin or the exterior skin layer in the amount from about 0.1 wt % to about 40 wt %, preferably from about 1.0 wt % to about 20 wt %, and most preferably from about 2.0 to about 10 wt %.

In order to enhance the adhesion between layers of the iridescent multilayer film, a polymer compatibilizer can be added into the first, second, or third polymeric resin or the polymeric resin of the exterior skin layers. The typical polymer compatibilizer includes without limitation functional polymer resins, such as oxidized polyethylene wax, or grafted copolymers, such as styrene-methyl methacrylate copolymer, with one part of the polymer compatibilizer chain miscible with one type of the polymeric resin and the other part of the polymer compatibilizer chain miscible with another type of the polymeric resin.

When the polymer compatibilizer is a functional polymer resin the resin typically contains polar groups. The preferred polar group contained in such compatibilizers, includes without limitation active hydrogen-containing polar groups (—SO₃H, —SO₂H, —SOH, —CONH₂, —CONHR, —CONH—, —OH, etc.), nitrogen-containing polar groups (—NCO, —OCN, —NO, —NO₂, —CONR₂, —CONR—, etc.), an epoxy group, carbonyl group-containing polar groups (—CHO, —COOH, —COOR, —COR, >C═O, —CSOR, —CSOH, etc.), phosphorus-containing polar groups (—P(OR)₂, —PO(OR)₂, —PO(SR)₂, —PS(OR)₂, —PO(SR)(OR), —PS(SR)(OR), etc.), boron-containing polar groups and the like. In the above general formulae, R represents an alkyl group, a phenyl group or an alkoxy group.

The amount of the polymer compatibilizer added to the first, second, or third polymeric resin or the polymeric resin of the exterior skin layers is from about 0.1 wt% to about 20 wt %, preferably from about 0.5 wt % to about 10 wt %, and most preferably from about 1 to about 5 wt %.

The iridescent multilayer films are usually made by a chill-roll casting technique in which melts of the thermoplastic polymeric resins from two or more extruders are collected by a feedblock which arranges them into a desired layered pattern. The very narrow multilayer stream flows through a single manifold flat film die with the layers simultaneously spread to the width of the die and thinned to the final die exit thickness. The number of layers and their thickness distribution can be changed by using a different feedblock module. Usually, the outermost layer or exterior skin layers on each side of the film is thicker than the internal layers so as to form a relatively thick skin in a substantially equal division. Preferably, the present film is made by a process disclosed in U.S. Pat. No. 3,801,429, incorporated herein by reference to the extent necessary to complete this disclosure.

The polymeric material selected for the exterior skin layer, which is the outmost layer or layers on each side of the film will depend upon the desired characteristics of the iridescent multilayer film. Therefore, the polymeric materials used for the internal layers may also be used for the exterior skin layers in different thicknesses and/or containing different functional additives. U.S. Pat. No. 5,451,449, incorporated herein by reference to the extent necessary to complete this disclosure, discloses that polyethylene terephthalate thermoplastic polyester was fed to the feedblock from one extruder, polymethyl methacrylate was fed to the feedblock from another extruder, and polybutylene terephthalate was added as a skin layer to each outer surface from a third extruder.

In a typical process making an optical core comprising a first and second layer types, the first layer type comprising a first polymeric resin and a functional additive; and the second layer type comprising a second polymeric resin and optionally containing a functional additive are extruded from two separate extruders. Following the extrusion, the melt streams are then filtered to remove undesirable particles and gels. Primary and secondary filters known in the art of polyester film manufacture may be used, with mesh sizes in the 1-30 micrometer range. While the prior art indicates the importance of such filtration to film cleanliness and surface properties, its significance in the present invention extends to the uniform distribution of the functional additives as well. Each melt stream is then conveyed through a neck tube into a gear pump used to regulate the continuous and uniform rate of polymer flow. A static mixing unit may be placed at the end of the neck tube carrying the melt from the gear pump into the multilayer feedblock, in order to ensure uniform melt stream temperature. The entire melt stream is heated uniformly to ensure uniform flow during melt processing.

Multilayer feedblocks are designed to divide two or more polymer melt streams into many layers each, interleave these layers, and merge the many layers of two or more polymers into a single multilayer stream. The layers from any given melt stream are created by sequentially bleeding off part of the stream from a main flow channel into side channel tubes that feed layer slots for the individual layers in the feed block manifold.

Many designs are possible, including those disclosed in U.S. Pat. Nos. 3,737,882; 3,884,606; and 3,687,589 to Schrenk et al. Methods have also been described to introduce a layer thickness gradient by controlling layer flow as described in U.S. Pat. Nos. 3,195,865; 3,182,965; 3,051,452; 3,687,589 and 5,094,788 to Schrenk et al, and in U.S. Pat. No. 5,389,324 to Lewis et al.

The side channel tubes and layer slots of the two or more melt streams are interleaved as desired to form alternating layers. The feed block's downstream-side manifold for the combined multilayer stack is shaped to compress and uniformly spread the layers transversely. Exterior skin layers may be fed nearest to the manifold walls from any of the melt streams used for the optical multilayer stack, or by a separate feed stream, in order to protect the thinner optical layers from the effects of wall stress and possible resulting flow instabilities.

In optical applications, especially for films intended to transmit or reflect a specific color or colors, very precise layer thickness uniformity in the film plane is required. The greater the amount of transverse spreading, the higher the likelihood of non-uniformity in the resulting layer thickness profile. Control of layer thickness is especially useful in producing films having specific layer thicknesses or thickness gradient profiles that are modified in a prescribed way throughout the thickness of the multilayer film. For example, several layer thickness designs have been described for infrared films which minimize higher order harmonics which result in color in the visible region of the spectrum. Examples of such film include those described in U.S. Pat. No. RE 3,034,605.

By designing the film or optical body containing nanoparticles of a certain particle diameter, the optical film can be made at least partially transparent to the visible light but blocking the penetration of UVA or UVB light due to the light scattering effect.

For the iridescent multilayer films when two polymeric resins are extruded to form an optical core containing a pair of adjacent “A” and “B” layers, such layers make up an optical repeating unit. The various layers in the film could have different thicknesses across the film. This is commonly referred to as the layer thickness gradient. The change of the thickness will change the reflective or scattering characteristics of the optical films. The layer thickness could also decrease, then increase, then decrease again from one major surface of the film to the other.

Thickness profiles such as this are helpful in producing sharpened spectral transitions. If desired for some applications, a discontinuity in optical thickness can be incorporated between the two stacks to give rise to a simple notch transmission band spectrum and other special characteristics.

Other thickness gradients may be achieved by arranging the individual layers into component multilayer stacks where one portion of the stacks has oppositely curved thickness profiles and the adjacent portions of the stacks have a slightly curved profile to match the curvature of the first portion of the stacks. The curved profile can follow any number of functional forms; the main purpose of the form is to break the exact repetition of thickness present in a quarter wave stack with layers tuned to only a single wavelength.

Each original portion of the multilayer stack that exits the feedblock manifold, is designed to reflect, transmit, over a given band of wavelengths and to exhibit a given characteristic or functionality, such as conductivity. More than one packet may be present as the multilayer stack leaves the feedblock. Thus, the film may be designed to provide optical performance and functional performance simultaneously. Multiple packets may be made of the same or of different combinations of two or more polymers and various functional additives. Multiple packets in which each packet is made of the same two or more polymers may be made by constructing the feedblock and its gradient plate in such a way that one melt train for each polymer feeds all packets, or each packet may be fed by a separate set of melt trains. Packets designed to confer on the film other non-optical properties, such as physical properties, may also be combined with optical packets in a single multilayer feedblock stack.

An alternative to creating dual or multiple packets in the feedblock is to create them from one feedblock packet via the use of a multiplier with multiplier ratio greater than one. Depending on the characteristics of the original packet and the multiplier ratio, the resulting packets can be made to have a unique combination of properties. It will be evident to one skilled in the art that the best combination of feedblock and multiplier strategies for any given optical film objective will depend on many factors, and must be determined on an individual basis.

These outer layers again perform as exterior skin layers within the multiplier. After multiplication and stacking, part of the exterior skin layer streams will form internal boundary layers between optical layers, while the rest will form skin layers. Thus the packets are separated by the exterior skin layers in this case. Additional exterior skin layers may be added and additional multiplication steps may be accomplished prior to final feed into a forming unit such as a die. Prior to such feed, final additional layers may be added to the outside of the multilayer stack, whether or not multiplication has been performed, and whether or not the exterior skin layers have been added prior to said multiplication, if any. These will form final skin layers and the external portions of the earlier-applied exterior skin layers will form sub-skins under these final skin layers. The die performs the additional compression and width spreading of the melt stream. Again, the die (including its internal manifold, pressure zones, etc.) is designed to create uniformity of the layer distribution across the web when the web exits the die.

While skin layers are frequently added to the multilayer stack to protect the thinner optical layers from the effects of wall stress and possible resulting flow instabilities, there may be other reasons as well to add a thick layer at the surface(s) of the film. Many will be apparent to those skilled in the art of film coextrusion, and these include surface properties such as adhesion, coatability, release, coefficient of friction, conductivity and the like, as well as barrier properties, weatherability, scratch and abrasion resistance, and others. In the case of films that are subsequently uniaxially or very unequally biaxially drawn, “splittiness”, or the tendency to tear or fail easily along the more highly drawn direction, can be substantially suppressed via the choice of a skin layer polymer which both adheres well to the sub-skin or nearest optical layer polymer and also is less prone itself to orientation upon draw. Examples include copolymers with less crystallinity as compared to the homopolymer, such as, a PEN copolymer (coPEN), as the exterior skin layer(s) over an optical multilayer stack containing PEN homopolymer. Marked suppression of splittiness can be expected in such a structure, compared to a similar film without the coPEN skin layer(s), when the films are highly drawn in one planar direction and undrawn or only slightly drawn in the orthogonal planar direction. One skilled in the art will be able to select similar skin layer polymers to complement other optical layer polymers and/or sub-skin polymers.

Temperature control is extremely important in the feedblock and subsequent flow leading to casting at the die lip. While temperature uniformity is often desired, in some cases deliberate temperature gradients in the feedblock or temperature differences of up to about 4041 C in the feed streams can be used to narrow or widen the stack layer thickness distribution. Feedstreams into the skin blocks can also be set at different temperatures than the feedblock temperature.

Shear rate is observed to affect viscosity and other Theological properties, such as elasticity. Flow stability sometimes appears to improve by matching the relative shape of the viscosity (or other Theological function) versus shear rate curves of the coextruded polymers. In other words, minimization of maximal mismatch between such curves may be an appropriate objective for flow stability. Thus, temperature differences at various stages in the flow can help to balance shear or other flow rate differences over the course of that flow.

The web is cast onto a chill roll, sometimes also referred to as a casting wheel or casting drum. The web may attain different surface texture, degree of crystallinity, or other properties at both sides due to wheel contact on one side and merely air contact on the other. This can be desirable in some applications and undesirable in others. When minimization of such sidedness differences is desired, a nip roll may be used in combination with the chill roll to enhance quenching or to provide smoothing onto what would otherwise be the air side of the cast web.

In some cases, it is important that one side of the multilayer stack be the side chosen for the superior quench that is attained on the chill roll side. For example, if the multilayer stack consists of a distribution of layer thicknesses, it is frequently desired to place the thinnest layers nearest the chill roll.

While the present invention is not so limited, an appreciation of various aspects of the invention will be gained through a discussion of the examples provided below.

### EXAMPLES

### Comparative Example 1

A coextruded film containing 380 core layers is produced by feeding the first and second resin streams to a feedblock from two separate extruders. The first resin stream contains 100 wt % polyethylene terephthalate. The second resin stream contains 100 wt % polymethyl methacrylate. The two exterior layers containing 100 wt % of polybutylene terephthalate are produced by feeding the resin from a third extruder.

### Example 1

A coextruded film containing 380 core layers is produced by feeding the first and second resin streams to a feedblock from two separate extruders. The first resin stream contains 95 wt % polyethylene terephthalate and 5 wt % alkyl silane treated zinc oxide with an average particle size of 40 nm, available from Sunjin Chemical. The second resin steam contains 100 wt % polymethyl methacrylate. The two exterior layers containing 100 wt % of polybutylene terephthalate are produced by feeding the resin from a third extruder.

### Example 2

A coextruded film containing 380 core layers is produced by feeding the first and second resin streams to a feedblock from two separate extruders. The first resin stream contains 97.5 wt % polyethylene terephthalate and 2.5 wt % alkyl silane treated zinc oxide with an average particle size of 40 nm, available from Sunjin Chemical. The second resin steam contains 97.5 wt % polymethyl methacrylate and 2.5 wt % alkyl silane treated zinc oxide mentioned above. The two exterior layers containing 100 wt % of polybutylene terephthalate are produced by feeding the resin from a third extruder.

The transmittance of UV light is measured by using a UV-Vis spectroscopy at wave lengths of 280 and 350 nm respectively, and the results show that the film of Comparative Example 1 has the highest UV transmittance and the Example 1 has the lowest UV transmittance. The lower UV transmittance of Example 1 as compared to that of Example 2 is surprising since both films of Example 1 and Example 2 contain the same amount of alkyl silane treated zinc oxide. The addition of zinc oxide to only one layer type apparently increases the effectiveness of zinc oxide as a UV blocking agent.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

What is claimed is:

1. A functional multilayer film comprising: an optical core comprising at least 10 alternating layers of at least a first and second layer types and two exterior skin layers; wherein said first layer type comprises a first polymeric resin and a first functional additive; and said second layer type comprises a second polymeric resin and optionally a second functional additive.

2. The film of claim 1, wherein the functional additive is selected from the group consisting of UV absorbers, conductive additives, oxygen scavengers, nanoparticle additives and mixtures thereof.

3. The film of claim 2, wherein the nanoparticle additive is selected from the group consisting of zinc oxides, titanium dioxides, silica oxides, aluminum oxides, zirconium oxides and mixtures thereof.

4. The film of claim 2, wherein the nanoparticle additive is zinc oxides.

5. The film of claim 2, wherein the nanoparticle additive has a weight average particle diameter of less than about 200 nm.

5. The film of claim 1, wherein the difference in index of refraction between the first polymeric resin and second polymeric resin is at least about 0.06.

6. The film of claim 1, wherein at least one of said two exterior skin layers comprises a polymeric resin and a functional additive.

7. The film of claim 6, wherein said functional additive is a conductive additive.

8. The film of claim 1, wherein at least one of the first layer type and the second layer type comprises additionally a polymer compatibilizer.

9. A functional multilayer film comprising: an optical core comprising at least 10 alternating layers of a first, second and third layer types and two exterior skin layers; wherein said first layer type comprises a first polymeric resin and a first functional additive; said second layer type comprises a second polymeric resin and optionally a second functional additive; said third layer type comprises a third polymeric resin and optionally a third functional additive.

10. The film of claim 9 wherein said first layer type comprises a first polymeric resin and a first functional additive; said second layer type comprises a second polymeric resin and a second functional additive; and said third layer type comprises a third polymeric resin and optionally a third functional additive.

11. The film of claim 9, wherein the functional additive is selected from the group consisting of UV absorbers, conductive additives, oxygen scavengers, nanoparticle additives and mixtures thereof.

12. The film of claim 11, wherein the nanoparticle additive is selected from the group consisting of zinc oxides, titanium dioxides, silica oxides, aluminum oxides, zirconium oxides and mixtures thereof.

13. The film of claim 11, wherein the nanoparticle additive is zinc oxides.

14. The film of claim 11, wherein the nanoparticle additive has a weight average particle diameter of less than about 200 nm.

15. The film of claim 9, wherein the difference in index of refraction between the first and second polymeric resins, the first and third polymeric resins, or the second and third polymeric resins is at least about 0.06.

16. The film of claim 9, wherein at least one of said two exterior skin layers comprises a polymeric resin and a functional additive.

17. The film of claim 16, wherein said functional additive is a conductive additive.

18. The film of claim 9, wherein at least one of the first, second and third layer types comprises additionally a polymer compatibilizer.
